(19) United States
(12) Patent Application Publication
(10) Pub. No.: US 2017/0154342 A1
(43) Pub. Date: Jun. 1, 2017

(54) Verification System

(71) Applicant: Safe Certificate, LLC, Sioux Falls, SD (US)

(72) Inventor: Jason Gant, Sioux Falls, SD (US)

(21) Appl. No.: 15/363,833

(22) Filed: Nov. 29, 2016

Related U.S. Application Data
(60) Provisional application No. 62/260,818, filed on Nov. 30, 2015.

(51) Int. Cl. G06Q 30/00

(52) U.S. Cl. CPC G06Q 30/018; G06Q 50/26

(57) ABSTRACT

A verification method performed by a verification entity including receiving, from a corporate entity, a request for verification prompted by a consumer, sending, to at least three independent sources, a request for corporate information corresponding to the corporate entity, comparing, by the verification entity, corporate information obtained from the corporate entity to corporate information received from the at least three independent sources, and providing, to the consumer, a safe certificate when the corporate information obtained from the corporate entity matches the corporate information received from the at least three independent sources.

### CROSS-REFERENCE TO RELATED APPLICATIONS

The present application claims priority to U.S. Provisional Patent Application No. 62/260,818 filed Nov. 30, 2015 by Jason Gant and entitled “Verification System,” which is incorporated herein by reference as if reproduced in its entirety.

### BACKGROUND

The merger of the Internet and commerce to form what is now known worldwide as electronic commerce, or “e-commerce,” has led to the proliferation of the use of the Internet and World Wide Web (the “Web”) for purchases of all kinds. Everything from airline tickets to automobiles to vitamins can be purchased on the Web, and such sales have experienced explosive growth.

As part of a typical on-line transaction process between a consumer and an electronic retailer, or “e-tailer,” the consumer may provide shipping, billing, and other sensitive information to the e-tailer. This information may be securely stored on the e-tailer's website and later accessible by the consumer upon entry of a username and passcode established by the consumer during a registration process.

Unfortunately, dishonest individuals or entities may spoof the websites of legitimate and reputable e-tailers in an attempt to trick consumers into supplying their shipping, billing, and other sensitive information to the dishonest individuals or entities instead of the e-tailer or business. If this type of information is compromised, the consumer may become the victim of identity theft, suffer a financial loss, and so on. Because of this risk, some consumers may be hesitant or unwilling to patronize e-tailers or other businesses with an on-line presence.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an embodiment of a consumer, a business entity, and a verification entity operating in the context of a verification system.

FIG. 2 is a diagram of an embodiment of a network element utilized in the verification system.

FIG. 3 is a message exchange protocol of an embodiment of a business entity verification process.

FIG. 4 is a message exchange protocol of an embodiment of a consumer utilizing the verification system.

FIG. 5 is an embodiment of a Safe Certificate displayed to a consumer pursuant to the verification system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for a system, apparatus, and method for verifying through at least three independent sources that a corporate entity operating a website on the Internet is the owner of the registered domain associated with the website, is in good standing with the state of organization of that corporate entity, and is verifiable as a legitimate corporate entity through another governmental authority, licensing agency, and so on. As will be more fully explained below, any corporate entity operating a website is able to request a seal of approval that can be used by a consumer in order to verify the authenticity of the website of the corporate entity. As such, the consumer is assured that any sensitive information they chose to share with the corporate entity will remain uncompromised and the corporate entity does not lose revenue due to the uncertainty of the consumer in using e-commerce. Thus, the present disclosure details a system of independent verifications of a website domain corporate ownership. The system provides for an independent review of three unique databases of data including, for example, the domain registration database, the state specific corporate registration certificate of good standing, and a state specific sales tax license certificate or a comparable state issued license certificate on an annual basis. The success of the website domain verification system is the independent cross referencing of the consistent data. Advantages will become apparent to those skilled in the art upon review of this disclosure.

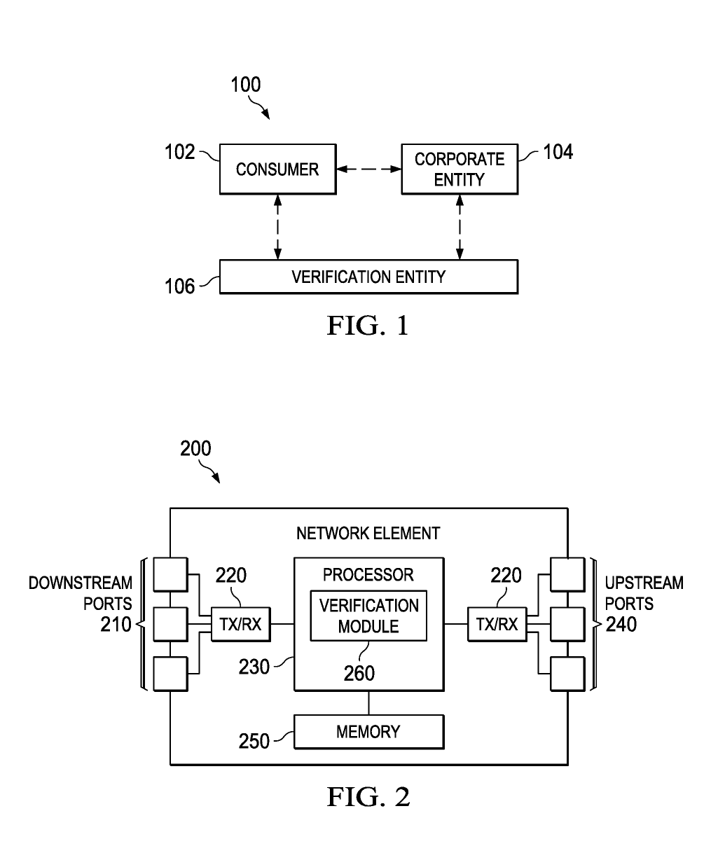

FIG. 1 is a diagram of a verification system 100 suitable for facilitating secure e-commerce transactions. Verification system 100 comprises a consumer 102, a business or corporate entity 104, and a verification entity 106 configured to communicate with each other over wired connections, wireless connections, or some combination thereof. In an embodiment, the consumer 102 represents a network element such as a personal computer, a mobile or smart phone, a tablet device, and the like. In an embodiment, each of the corporate entity 104 and the verification entity 106 represent a network element such as, for example, a server, computer, data center, and the like.

FIG. 2 is a diagram of an embodiment of a network element for operating in a verification system. For example, the network element 200 is the consumer 102, the corporate entity 104, or the verification entity 106 in the verification system 100 of FIG. 1. At least some of the features/methods described in this disclosure are implemented in the network element 200. For instance, the features/methods of this disclosure are implemented using hardware, firmware, and/or software installed to run on hardware. The network element 200 is a device (e.g., a server, a personal computer, a thin client, a user-equipment, a mobile communications device, etc.) that transports data through a network, system, and/or domain and/or any device that provides services to other devices in a network or performs computational functions. Moreover, the terms network “element,” network “node,” network “component,” network “module,” and/or similar terms may be interchangeably used to generally describe a network device and do not have a particular or special meaning unless otherwise specifically stated and/or claimed within the disclosure. In one embodiment, the network element 200 is an apparatus configured to implement the verification methods and processes disclosed herein.

The network element 200 comprises one or more downstream ports 210 coupled to a transceiver (Tx/Rx) 220, which are transmitters, receivers, or combinations thereof. The Tx/Rx 220 transmits and/or receives frames from other network nodes via the downstream ports 210. Similarly, the network element 200 comprises another Tx/Rx 220 coupled to a plurality of upstream ports 240, wherein the Tx/Rx 220 transmits and/or receives frames from other nodes via the upstream ports 240. The downstream ports 210 and/or the upstream ports 240 may include electrical and/or optical transmitting and/or receiving components. In another embodiment, the network element 200 comprises one or more antennas coupled to the Tx/Rx 220. The Tx/Rx 220 transmits and/or receives data (e.g., packets) from other network elements wirelessly via the one or more antennas.

A processor 230 is coupled to the Tx/Rx 220 and is configured to process a data transmission to determine and cancel narrowband ingress noise. In an embodiment, the processor 230 comprises one or more multi-core processors and/or memory modules 250, which functions as data stores, buffers, etc. The processor 230 is implemented as a general processor or as part of one or more application specific integrated circuits (ASICs), field-programmable gate arrays (FPGAs), and/or digital signal processors (DSPs). Although illustrated as a single processor, the processor 230 is not so limited and alternatively comprises multiple processors. The processor 230 further comprises a verification module 260 configured to perform the verification processes described herein.

FIG. 2 also illustrates that a memory module 250 is coupled to the processor 230 and is a non-transitory medium configured to store various types of data. Memory module 250 comprises memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage is used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 250 may be used to house the instructions for carrying out the various embodiments described herein. For example, alternatively, the memory module 250 comprises a verification module 260, which is executed according to instructions from processor 230, in order to carry out the verification processes used by the consumer 102, the corporate entity 104, or the verification entity 106 of FIG. 1.

It is understood that by programming and/or loading executable instructions onto the network element 200, at least one of the processor 230 and/or the memory module 250 are changed, transforming the network element 200 in part into a particular machine or apparatus, for example, a network element having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable and will be produced in large volume may be preferred to be implemented in hardware (e.g., in an ASIC) because for large production runs the hardware implementation may be less expensive than software implementations. Often a design may be developed and tested in a software form and then later transformed, by design rules well-known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose multi-core processor) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM, flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

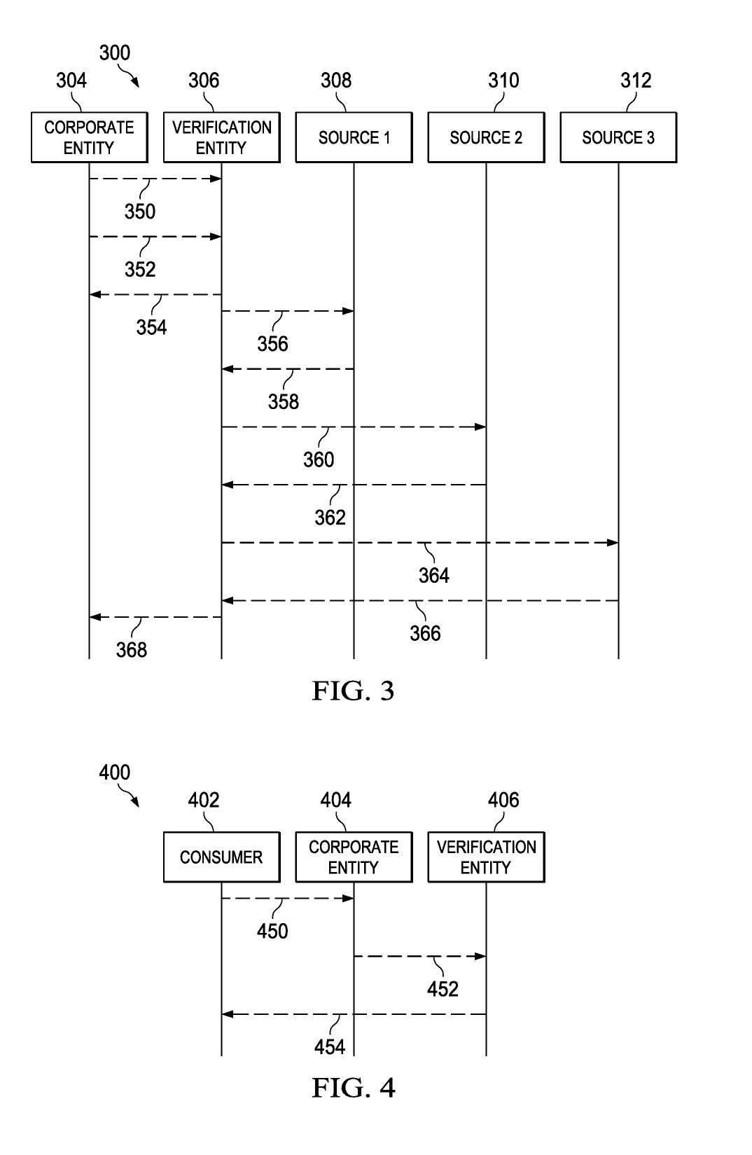

FIG. 3 is a message exchange protocol 300 of an embodiment of a business entity verification process used to verify a corporate entity 304. Corporate entity 304 is similar to corporate entity 104 in FIG. 1. Verification entity 306 is similar to verification entity 106 in FIG. 1. Message exchange protocol 300 may be implemented by the verification entity 306.

At step 350, the verification entity 306 collects corporate information from the corporate entity 304. This may be referred to herein as a “sign-up” process. In an embodiment, the corporate information collected or requested during sign up includes, but is not limited to, the first and last name of the person providing the information, their title, an electronic mail (“e-mail”) address, a phone number, a street address, and the city, state, and zip code of the person providing the information. In an embodiment, the person providing the corporate information may be prompted to set up an account with the verification entity 306 by providing a username and password.

The corporate information collected or requested at sign up may also include the corporate name, the entity type (e.g., corporation, limited liability company (LLC), partnership, etc.), the date of incorporation, the state of incorporation, the corporate website, and a phone and fax number, a street address, and the city, state, and zip code of the corporate entity 304, an identification of the corporate entity's industry (e.g., healthcare, education, legal, etc.), and a brief description of the business. Once this or other information has been entered, the verification entity 306 may create a client identification (ID) that corresponds to the corporate entity 304.

In an embodiment, the corporate information is collected by the verification entity 306 from the corporate entity 304 using a secure website managed by the verification entity 306 and accessible by the corporate entity 304 using a browser. The browser may display a variety of input fields, drop down boxes, check boxes, and the like, to collect the corporate information from the corporate entity 304.

At step 352, the verification entity 306 collects payment information from the corporate entity 304. The payment information collected will facilitate payment for the verification services provided to the corporate entity 304. For the convenience of the person entering the corporate information, the input windows on the billing information screen of the browser described above may be auto-filled with previously entered information. In an embodiment, the person that completed the sign up process for the corporate entity 304 may be prompted to select or identify the relevant state in order to determine a sales tax amount.

In an embodiment, the verification entity 306 may use the authorize.net application (“api”) in order to facilitate credit and debit card and electronic check (“e-check”) payments. In an embodiment, the verification entity 306 accepts payments using VISA, MasterCard, AMEX, and Discover cards, electronic checks, bitcoins, or other forms of currency. For any payments made, the verification entity 306 may generate a unique payment number and record the time and date. In step 354, the verification entity 306 may dispatch one or more e-mails to the corporate entity 304 as confirmation that registration has been completed and/or as confirmation of payment. In an embodiment, the confirmations may be mailed, faxed, or otherwise sent to the corporate entity 304 in lieu of, or in addition to, the e-mail messages. While steps 350 and 352 are shown as separate in FIG. 3, it should be understood that these steps may be combined into a single step.

In step 356, the verification entity 306 contacts a first source 308 in order to verify information corresponding to the corporate entity 304. In an embodiment, the first source 308 is a domain name registrar for the corporate website identified during the sign-up process noted above. The Internet Corporation For Assigned Names and Numbers (“ICANN”) is the entity responsible for issuing domain names for the Internet. ICANN has established that the registrant of a domain name include the following data: organization, street, city, state, postal code, country, phone, fax, and email. In step 358, the verification entity 306 receives from the first source 308 (e.g., the domain name registrar) the information collected and/or recorded by the domain name registrar when the corporate website was created. The verification entity 306 then compares the information collected and/or recorded by the domain name registrar with the information collected during the sign-up process to determine whether or not the information matches.

In step 360, the verification entity 306 contacts a second source 310 in order to verify information corresponding to the corporate entity 304. Notably, the second source 310 is independent of the first source 308. In an embodiment, the second source 310 is the Secretary of State, the office of the Lieutenant Governor, and/or other state agency for the state where the corporate entity 304 was organized as identified during the sign-up process noted above. Corporate registration of a business in the United States is administered by each of the individual states. The office of the Secretary of State, the office of the Lieutenant Governor, and/or other state agency is the issuing agency of company formations. These entities require the following data: corporate name, street, city, state, postal code, and board of directors, managers, officers, and/or owners of the corporation. The independent verification of a corporate registration is through a certificate of good standing or certificate of authorization that is issued by all states. This state issued certificate is the only state government document that proves a company is up-to-date on its state fee payments, has filed an annual report, and/or has paid its franchise taxes. In step 362, the verification entity 306 receives from the second source 310 (e.g., the Secretary of State) the information collected and/or recorded by the agencies noted above when the corporate entity was established. The verification entity 306 then compares the information collected and/or recorded by the office of the Secretary of State, the office of the Lieutenant Governor, and/or other state agency with the information collected during the sign-up process to determine whether or not the information matches.

In step 364, the verification entity 306 contacts a third source 312 in order to verify information corresponding to the corporate entity 304. Notably, the third source 312 is independent of both the first source 308 and the second source 310. In an embodiment, the third source 312 is the comptroller or similar state agency responsible for collecting sales, use, or other tax revenue for the state. Forty-five states have statewide sales and/or use taxes that are collected as revenue for state government operations. Each of these states has a state government agency like a comptroller that is responsible for licensing each business that is engaged in business operations within their respective state. This state government agency requires the following data: corporate name, street, city, state, postal code. The independent verification of a state issued license is through contacting the state agency issuing the license to determine that the company is indeed licensed to collect sales and/or use taxes. For a business that cannot be licensed through a sales and/or use tax licensing agency, then the third verification of the company may be through another state agency that issues a license such as a real estate, healthcare, automotive or other types of license. In step 366, the verification entity 306 receives from the third source 312 (e.g., the State Comptroller) the information collected and/or recorded by the comptroller when, for example, the corporate entity requested and received a tax identification number. The verification entity 306 then compares the information collected and/or recorded by the office of the State Comptroller with the information collected during the sign-up process to determine whether or not the information matches.

In an embodiment, steps 356, 360, and 364 may be performed simultaneously. In an embodiment, steps 356, 360, and 364 may be performed consecutively. Regardless of the ordering, as shown in steps 356, 360, and 364, the verification entity 306 uses at least three independent sources to verify that the corporate entity is valid, in good standing, and/or a legitimate business. Indeed, the message exchange protocol 300 provides the verification of domain name, corporate name, and state license name by comparing and verifying at least the following: organization, street, city, state, and postal code, and may also verify phone, fax, and email. Such verification is done directly through the domain registrar and one or more state agencies. The verification is independent and guaranteed by the collective value of the state issued certificate of good standing and the state issued license, as well as the information collected by the domain registrar.

At step 368, the verification entity informs the corporate entity 304 whether there has been a sufficient match between the information provided at sign-up and the information obtained from the first, second, and third sources 308, 310, and 312. In an embodiment, the verification entity 306 may dispatch one or more e-mails to the corporate entity 304 pursuant to step 368 to confirm that ownership of the domain name has been verified or as notification that the domain name could not be verified. Either of these notifications may be mailed, faxed, or otherwise sent to the corporate entity 304 in lieu of, or in addition to, the e-mail messages.

In an embodiment, the verification entity 306 may dispatch one or more e-mails to the corporate entity 304 pursuant to step 368 to confirm that a certificate of good standing has been received by the verification entity 306 for the corporate entity 304 or as notification that a certificate of good standing was not available for the corporate entity 304. In an embodiment, a copy of the certificate of good standing may be provided to the corporate entity 304. Either of these notifications may be mailed, faxed, or otherwise sent to the corporate entity 304 in lieu of, or in addition to, the e-mail messages.

In an embodiment, the verification entity 306 may dispatch one or more e-mails to the corporate entity 304 pursuant to step 368 to confirm that the sales/use tax, professional license, or other record has been confirmed for the corporate entity 304 or as notification that no such confirmation was able to be made for the corporate entity 304. Either of these notifications may be mailed, faxed, or otherwise sent to the corporate entity 304 in lieu of, or in addition to, the e-mail messages.

Step 368 may be performed at intervals such as, for example, after each of the first, second, and third sources 308, 310, and 312 have been checked and the corporate information confirmed or verified by the source. In an embodiment, step 368 may be performed once after all of the sources have been checked and the corporate information verified by the sources. In an embodiment, step 368 may also be performed after several, but not all, of the sources have been checked.

If each of the first, second, and third sources 308, 310, and 312 have been checked and the corporate information confirmed or verified to match the corporate information supplied by the corporate entity 304 during sign-up, step 368 may include providing a seal, a logo, hypertext mark-up language (HTML) code and/or a hyperlink that the corporate entity 304 is able to include on or embed in their website. In an embodiment, step 368 may be partially or fully performed by requesting that the corporate entity 304 log in to their account with the verification entity 306 to obtain the seal, logo, HTML code and/or hyperlink. The seal, which may be referred to as a Safe Certificate seal, indicates to consumers and others that the corporate entity 304 has been verified as a valid business that owns the domain of the website visited, as described herein. In an embodiment, the seal is, or resembles, a logo or service mark of the verification entity 306. When included on the website of the corporate entity 304, the seal is intended to provide a mechanism for consumers to ensure that they are dealing with a reputable corporate entity 304. In other words, the seal is intended to instill confidence in consumers and provide assurances that they are dealing with a legitimate business.

FIG. 4 is a message exchange protocol 400 of an embodiment of a consumer using the business entity verification process described herein. Consumer 402 is similar to the consumer 102 of FIG. 1. Corporate entity 404 is similar to corporate entity 104, 304 in FIGS. 1 and 3. Verification entity 406 is similar to verification entity 106, 306 in FIGS. 1 and 3. Message exchange protocol 400 may be implemented, at least in part, by the verification entity 406.

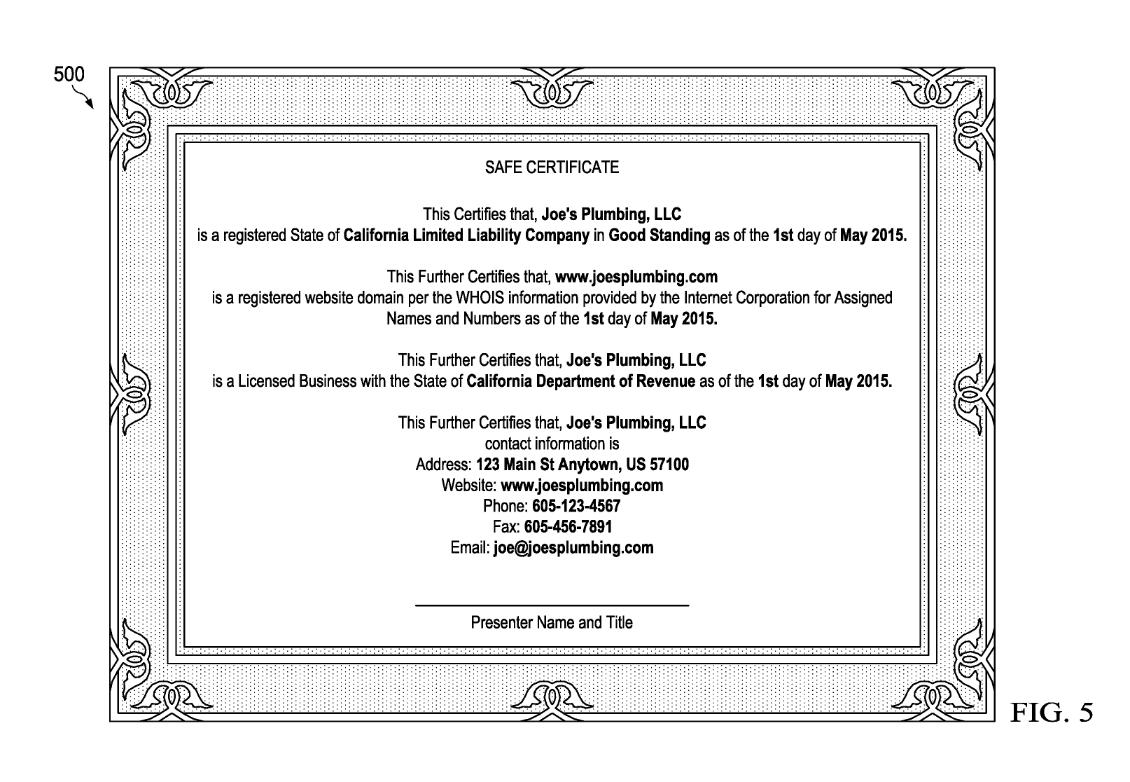

At step 450, the consumer 402 visits the website of the corporate entity 404 and, upon seeing the Safe Certificate seal, clicks on it for verification that the corporate entity 404 owns the domain and is a valid entity. In response to the click, the HTML code embedded in the website of the corporate entity 404 generates a request 452 to the verification entity 406 that the consumer 402 be provided with verification that the corporate entity 404 can be trusted. At this point, the verification entity 406 may have already performed a verification of the corporate entity 404, as described above with regard to FIG. 3. If not, such verification process may be completed. In an embodiment, the verification entity 406 confirms that the corporate entity 404 is still verifiable. Thereafter, at step 454 the verification entity 406 provides a Safe Certificate to the consumer 402. In an embodiment, the Safe Certificate is displayed as a pop-up window in the browser of the consumer 402. In an embodiment, the Safe Certificate resembles the certificate 500 illustrated in FIG. 5. It should be understood that the certificate 500 may contain other information and that certificate in FIG. 5 is for illustrative purposes. Upon viewing the certificate 500 in FIG. 5, the consumer 402 is assured that the corporate entity 404 is the owner of the registered domain associated with the website, is in good standing with the state of organization of that corporate entity, and is verifiable as a legitimate business through another governmental authority, licensing agency, and so on.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A verification method performed by a verification entity, comprising:
receiving, from a corporate entity, a request for verification prompted by a consumer;
sending, to at least three independent sources, a request for corporate information identifying the corporate entity;
comparing, by the verification entity, corporate information obtained from the corporate entity to the corporate information received from the at least three independent sources; and
providing, to the consumer, a safe certificate when the corporate information obtained from the corporate entity matches the corporate information received from the at least three independent sources.

2. The verification method of claim 1, wherein the request for verification is a request to verify that the corporate entity is trustworthy.

3. The verification method of claim 1, wherein the safe certificate is not provided to the corporate entity.

4. The verification method of claim 1, wherein the request for corporate information is sent to the at least three independent sources simultaneously.

5. The verification method of claim 1, wherein the request for corporate information is sent to the at least three independent sources consecutively.

6. The verification method of claim 1, wherein the at least three independent sources includes at least three of a domain name registrar, a state agency responsible for chartering corporate entities, a state agency responsible for collecting taxes, and a state licensing agency.

7. The verification method of claim 1, wherein the corporate information obtained from the corporate entity is collected by the verification entity during a registration process preceding the request for verification.

8. The verification method of claim 7, wherein the registration process includes the verification entity obtaining payment information from the corporate entity.

9. The verification method of claim 8, wherein the request for verification from the corporate entity is preceded by the verification entity sending a registration confirmation message to the corporate entity.

10. A verification entity, comprising:
a memory; and
a processor operably coupled to the memory and configured to:
obtain, from a corporate entity, corporate information identifying the corporate entity during a registration process;
receive, from a corporate entity, a request for verification prompted by a consumer after the registration process has been completed;
obtain, from at least three independent sources, corporate information identifying the corporate entity in response to the request for verification;
compare the corporate information obtained from the corporate entity to the corporate information received from the at least three independent sources; and
a transmitter operably coupled to the processor and configured to provide a safe certificate to the consumer when the corporate information obtained from the corporate entity matches the corporate information received from the at least three independent sources.

11. The verification entity of claim 10, wherein the transmitter does not transmit the safe certificate to the corporate entity.

12. The verification entity of claim 10, wherein the corporate information obtained from the at least three independent sources is obtained simultaneously from each source.

13. The verification entity of claim 10, wherein the corporate information obtained from the at least three independent sources is obtained consecutively.

14. The verification entity of claim 10, wherein the at least three independent sources includes at least three of a domain name registrar, a state agency responsible for chartering corporate entities, a state agency responsible for collecting taxes, and a state licensing agency.

15. A verification method performed by a verification entity, comprising:
comparing, by the verification entity, corporate information obtained from a corporate entity to corporate information received from at least three independent sources;
receiving, from the corporate entity, a request that a safe certificate be provided to a consumer following a request for the safe certificate made by the consumer; and
directly sending, to the consumer, the safe certificate when the corporate information obtained from the corporate entity matches the corporate information received from the at least three independent sources.

16. The verification method of claim 15, wherein the corporate information obtained from the at least three independent sources is obtained consecutively; wherein a safe certificate seal is provided to the corporate entity; and wherein the safe certificate is not provided to the corporate entity.

17. The verification method of claim 15, further comprising providing, to the corporate entity, a safe certificate seal.

18. The verification method of claim 17, wherein the safe certificate seal is configured to be included on or embedded in a website of the corporate entity.

19. The verification method of claim 15, further comprising completing a registration process to register the corporate entity prior to comparison of the corporate information obtained from the corporate entity and the at least three independent sources.

20. The verification method of claim 15, wherein the at least three independent sources includes at least three of a domain name registrar, a state agency responsible for chartering corporate entities, a state agency responsible for collecting taxes, and a state licensing agency
